(19) United States
(12) Patent Application Publication
(10) Pub. No.: US 2005/0209754 A1
(43) Pub. Date: Sep. 22, 2005

(54) Passive safety system

(76) Inventor: Shinichi Kiribayashi, Anjo-city (JP)

Correspondence Address: POSZ LAW GROUP, PLC, 12040 SOUTH LAKES DRIVE, SUITE 101, RESTON, VA, 20191, US

(21) Appl. No.: 11/079,195

(22) Filed: Mar. 15, 2005

(30) Foreign Application Priority Data
Mar. 18, 2004 (JP) 2004-78974

(51) Int. Cl. B60R 21/32

(52) U.S. Cl. 701/45; 280/735; 180/273

(57) ABSTRACT

A passive safety system includes an occupant detection electronic control unit (ECU) and an airbag electronic control unit (ECU). The occupant detection ECU determines a seat occupancy condition of a vehicle seat and outputs a result of the determination as seat occupancy information. The airbag ECU has a collision determination circuit and an electrically erasable programmable read-only memory (EEPROM). The collision determination circuit sets an airbag either in an inflation permitted condition or an inflation prohibited condition based on the seat occupancy information. The collision determination circuit determines whether a collision occurs and outputs a drive signal for driving the airbag when a collision is determined and the airbag is set in the inflation permitted condition. The EEPROM performs writing operation triggered by the drive signal for storing the seat occupancy information.

### CROSS REFERENCE TO RELATED APPLICATION

This application is based on and incorporates herein by reference Japanese Patent Application No. 2004-78974 filed on Mar. 18, 2004.

### FIELD OF THE INVENTION

The present invention relates to a passive safety system.

### BACKGROUND OF THE INVENTION

A passive safety system includes an occupant detection electronic control unit (ECU) and an airbag electronic control unit (ECU). The occupant detection ECU determines a seat occupancy condition based on sensor information. A result of the determination is transmitted to the airbag ECU as seat occupancy information. The airbag ECU sets an airbag either in an inflation permitted condition or an inflation prohibited condition. The airbag ECU determines a collision of a vehicle. More specifically, it determines that a collision of the vehicle when an acceleration of the vehicle detected by an acceleration sensor exceeds a threshold. The airbag ECU heats a squib when a collision and an airbag permitted condition are determined. An inflator of the airbag is turned on and the airbag is inflated with expansion pressure of the inflator.

A passive safety system proposed in JP-A-10-503445 has an EPROM in an occupant detection ECU for storing data on seat occupancy conditions before and after a collision. The data on seat occupancy conditions is collected after a collision and used for an analysis of an accident or research. In this system, a collision signal is inputted from the airbag ECU to the occupant detection ECU as a trigger for storing the data on seat occupancy conditions. Thus, a two-way communication is required between the airbag ECU and the occupant detection ECU.

### SUMMARY OF THE INVENTION

The present invention has an objective to provide a passive safety system that stores data on seat occupancy conditions without a two-way communication between a passive safety ECU, such as an airbag ECU, and an occupant detection ECU. A passive safety system of the present invention includes an occupant detection ECU and a passive safety ECU. The occupant detection ECU determines a seat occupancy condition of a vehicle seat and outputs a result of the determination as seat occupancy information.

The passive safety ECU includes a collision determination circuit and a nonvolatile memory. The collision determination circuit sets a passive safety device in an operation permitted condition or an operation prohibited condition based on the seat occupancy conditions. It determines whether a collision occurs and transmits a drive signal for driving the passive safety device when the collision is determined and the passive safety device is set in the operation permitted condition. The nonvolatile memory performs writing operation for storing the seat occupancy information trigger by the drive signal.

In the passive safety system, the collision determination and the output of the drive signal are performed by the passive safety ECU. Moreover, the seat occupancy information is stored by the passive safety ECU. Namely, storing necessary information for driving the passive safety device is all stored by the passive safety ECU. To store such information, a nonvolatile memory is provided in the passive safety ECU. With this configuration, two-way communication is not required between the occupant detection ECU and the passive safety ECU. Thus, the manufacturing cost of the passive safety system is lower than that of a passive safety system that requires two-way communication between an occupant detection ECU and a passive safety ECU.

The nonvolatile memory is preferably an electrically erasable programmable read-only memory (EEPROM). With this configuration, the seat occupancy information is collected after a collision and electrically erased.

### BRIEF DESCRIPTION OF THE DRAWINGS

The above and other objectives, features and advantages of the present invention will become more apparent from the following detailed description made with reference to the accompanying drawings. In the drawings:

FIG. 1 is a perspective view of a vehicle seat to which a passive safety system is connected according to an embodiment of the present invention; and

FIG. 2 is a block diagram of the passive safety system according to the embodiment.

### DETAILED DESCRIPTION OF THE PREFERRED EMBODIMENT

The preferred embodiments of the present invention will be explained with reference to the accompanying drawings. In the drawings, the same numerals are used for the same components and devices.

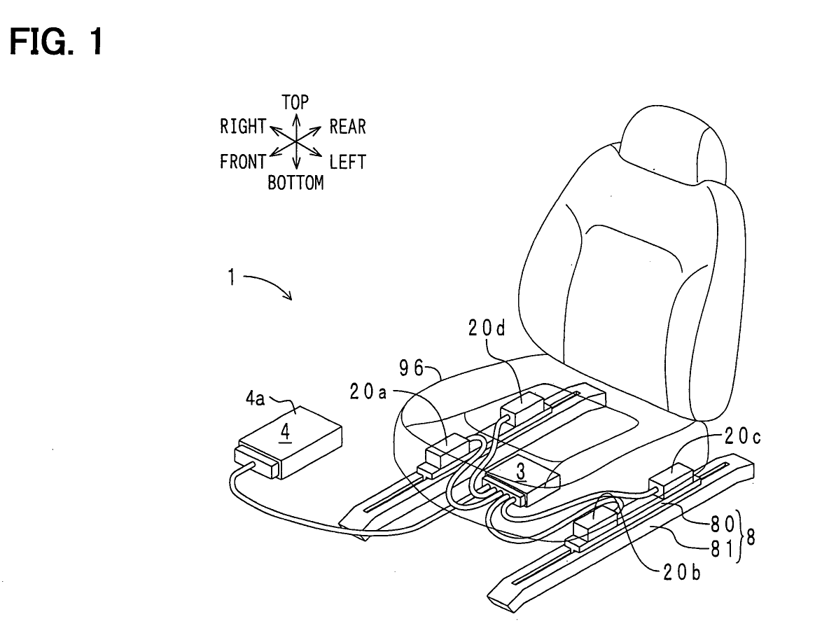

Referring to FIG. 1, a passive safety system 1 is arranged around a seat 96 of a vehicle. The passive safety system 1 includes load sensors 20a-20d, an occupant detection electronic control unit (ECU) 3, and an airbag electronic control unit (ECU) 4. Seat rails 8 are arranged parallel to each other in the front-to-rear direction of the vehicle under the seat 96. Each seat rails 8 includes an upper rail 80 and a lower rail 81. The lower rail 81 is fixed to a vehicle floor (not shown). The upper rail 80 is assembled to the lower rail 81 such that it can slide along the lower rail 81 in the front-to-rear direction of the vehicle. The seat 96 can slide with the upper rail 80 in the front-to-rear direction.

The load sensors 20a-20d are arranged between seat frames (not shown) and the upper rails 80. The load sensor 20a, 20b, 20c, 20d are arranged in the right front, the left front, the left rear, and the right rear areas of the seat 96, respectively. The occupant detection ECU 3 is fixed to the bottom of the seat 96. The load-sensors 20a-20d and the passenger detection ECU 3 are connected with each other via wire harnesses. The passenger detection ECU 3 is also connected to the airbag ECU 4 via a wire harness. The airbag ECU is an example of passive safety ECUs. The airbag ECU 4 is installed under an instrument panel (not shown).

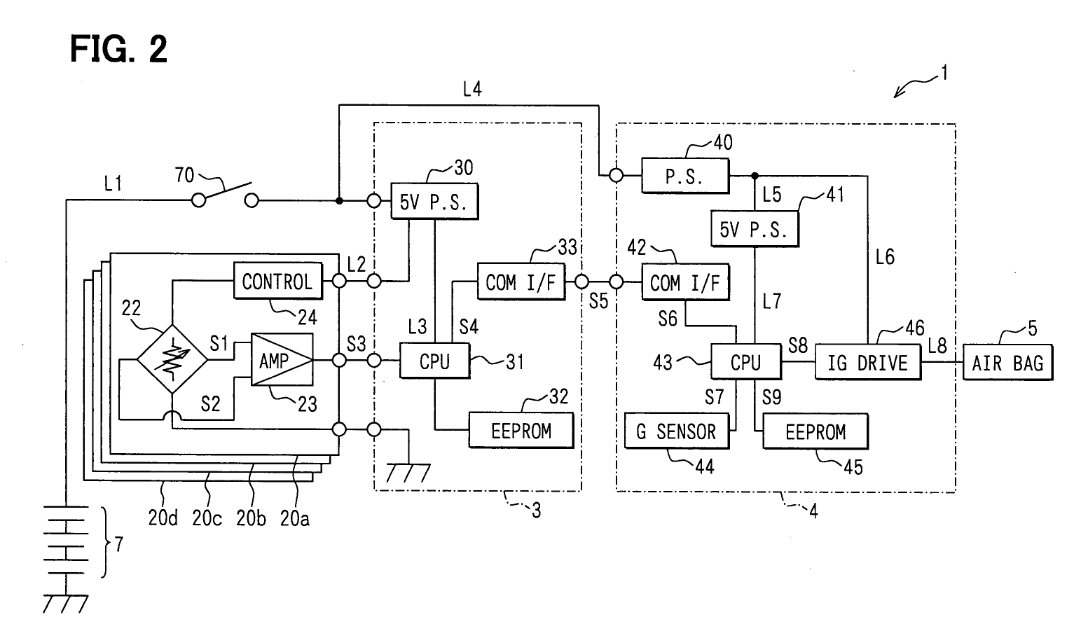

Referring to FIG. 2, the load sensor 20a has a gage circuit 22, an amplifier 23, and a control circuit 24. The gage circuit 22 includes four strain gages that form a bridge circuit. The amplifier 23 amplifies a voltage signal outputted from the gage circuit 22. The control circuit 24 adjusts a gain of the voltage amplification performed by the amplifier 23. The load sensors 20b-20d have the same configurations as the load sensor 20a.

The occupant detection ECU 3 has a central processing unit (CPU) 31, an electrically erasable programmable read-only memory (EEPROM) 32, and a communication interface (I/F) 33. A 5-V power supply circuit 30 is connected to a battery 7 of the vehicle via an ignition switch 70. The CPU 31 includes an analog-to-digital (A/D) converter, a random access memory (RAM), and a read-only memory (ROM) although they are not shown in figures. The A/D converter converts an analog voltage signal inputted from the amplifier 23 into a digital signal. The RAM temporarily stores the digital signal. The RAM stores a program for the seat occupancy detection. The EEPROM 32 stores errors of the load sensors 20a-20d whenever they occur. Data stored in the EEPROM 32 is electrically erasable and overwritten. The communication I/F 33 transmits the seat occupancy information from the CPU 31 to the airbag ECU 4.

The airbag ECU 4 has a power supply circuit 40, a 5-V power supply circuit 41, a communication I/F 42, a CPU 43, a G sensor 44, an EEPROM 45, and an inflator driving circuit 46. The CPU 43 is an example of a collision determination circuit. The power supply circuit 40 is connected to the battery 7 via the ignition switch 70. The 5-V power supply circuit 41 and the inflator driving circuit 46 are connected to the battery 7 via the power supply circuit 40 and the ignition switch 70. The communication I/F 42 receives the seat occupancy information from the communication I/F 33 of the occupant detection ECU 3. The G sensor 44 is an electrical acceleration sensor that can detect an acceleration, or a deceleration, of the vehicle.

The EEPROM 45 electrically deletes and overwrites data. The CPU 43 has a RAM and a ROM (not shown). The RAM temporarily stores the seat occupancy information and data about the acceleration detected by the G sensor 44. The ROM stores a program for the collision determination written in advance. The inflator driving circuit 46 has a switching element (not shown). The inflator driving circuit 46 heats a squib (not shown) of an airbag 5. The heated squib ignites an inflator (not shown). The airbag 5 is inflated with an expansion pressure produced by the inflator. The airbag 5 is an example of passive safety devices.

12-V power is supplied from the battery 7 to the 5-V power supply circuit 30 via the first power supply line L1 when the ignition switch 70 is turned on. The 5-V power supply circuit 30 transforms the 12-V power to a 5-V power. The 5-V power is supplied to the load sensors 20a-20d via the second power supply line L2. It is also supplied to the CPU 31 via the third power supply line L3.

The 12-V power is also supplied to the power supply circuit 40 via the fourth power supply line L4, and to the inflator driving circuit 46 via the sixth power supply line L6. It is also supplied to the squib via the switching element and the eighth power supply line L8, and to the 5-V power supply circuit 41 via the fifth power supply line L5. The 5-V power supply circuit 41 transforms the 12-V power to 5-V power. The 5-V power is supplied to the CPU 43 via the seventh power supply line L7.

A load applied to the seat 96 is detected by the load sensors 20a-20d. A case that a load is detected by the load sensor 20a will be discussed for example. A constant voltage is applied to the strain gages of the gage circuit 22. Resistances of the strain gages vary when a load is applied to the right front area of the seat 96. The bridge circuit loses a balance and a small voltage develops in the gage circuit 22. A signal of the voltage is transmitted from the gage circuit 22 to the amplifier 23 via the first and the second signal lines S1, S2.

The amplifier 23 amplifies the signal and outputs it to the A/D converter of the CPU 31 via the third signal line S3. The A/D converter converts the signal from analog to digital. The A/D converter receives signals from the load sensor 20b-20d and converts them from analog to digital. The four digital signals are temporarily stored in the RAM of the CPU 31 and added by the CPU 31 after read out of the RAM. The CPU 31 compares the total sum of the four digital signals with a threshold stored in the ROM and determines conditions of the seat 96.

More specifically, the CPU 31 determines that the seat 96 is empty if the total sum is equal to or smaller than an empty-seat threshold Wₜₕ₁ (total sum≦Wₜₕ₁). The CPU 31 determines that the seat 96 is occupied by a child if the total sum is over the empty-seat threshold Wₜₕ₁ and equal to or smaller than an adult/child threshold Wₜₕ₂ (Wₜₕ₁<total sum≦Wₜₕ₂). The CPU 31 determines that the seat 96 is occupied by an adult if the total sum is over the adult/child threshold (Wₜₕ₂<total sum).

A result of the determination is transmitted to the communication I/F 42 of the airbag ECU 4 via the fourth signal line S4, the communication I/F 33, the fifth signal line S5 as seat occupancy information. The seat occupancy information is inputted to the CPU 43 via the sixth signal line S6. The CPU 43 sets the airbag 5 either in the inflation permitted condition, that is, an operation permitted condition, or the inflation prohibited condition, that is, an operation prohibited condition. More specifically, the CPU 43 sets the airbag 5 in the inflation prohibited condition when the seat occupancy information indicates that the seat 96 is empty or occupied by a child. It sets the airbag 5 in the inflation permitted condition when the seat occupancy information indicates that the seat 96 is occupied by an adult. The seat occupancy information is periodically inputted to the CPU 43, namely, it is updated.

The CPU 43 receives data about the acceleration from the G sensor 44 via the seventh signal line S7. The CPU 43 integrates the acceleration data by section and calculates a moving average. The CPU 43 compares the moving average with a collision determination threshold stored in the ROM of the CPU 43 and determines whether a collision occurs. The CPU 43 determines no occurrence of a collision if the moving average is equal to or smaller than the collision determination threshold Gₜₕ. The CPU j43 determines an occurrence of a collision if the moving average is over the collision determination threshold Gₜₕ.

The CPU 43 outputs an ignition signal, which is a drive signal, to the inflator driving circuit 46 via the eighth signal line S8 when the collision is determined and the airbag 5 is in the inflation permitted condition. The switching element of the inflator driving circuit 46 is turned on when the ignition signal is inputted. The power supply line L1, L4, L6, L8 start conducting when the switching element is turned on. The squib of the airbag 5 is heated and the inflator is ignited. The airbag 5 is inflated with the expansion pressure of the inflator and quickly ejected from an instrument panel of the vehicle.

The seat occupancy information and collision information are transmitted from the CPU 43 to the EEPROM 45 via the ninth signal line S9 when the ignition signal is inputted via the eighth signal line S8 as a trigger. The collision information contains the acceleration detected by the G sensor 44. The seat occupancy information and the collision information, indicating conditions of the seat 96 and the acceleration between the 80 ms before the output of the ignition signal and 20 ms after the output of the ignition signal, are stored in the EEPROM 45. The EEPROM 45 performs writing operation for storing the seat occupancy information triggered by the ignition signal.

The EEPROM 45 is preferable to be able to store a total of 100 ms information and periods before and after the output of the ignition signal can be changed. It is preferable to set the period before the output of the ignition signal longer than the period after the output of the ignition signal.

The passive safety system 1 includes the EEPROM 45 that stores the seat occupancy information around the time when the ignition signal is outputted in the airbag ECU 4. Two-way communication is not required between the occupant detection ECU 3 and the airbag ECU 4. Thus, the manufacturing cost of the passive safety system 1 is lower than a passive safety system that requires two-way communication between an occupant detection ECU and an airbag ECU.

The EEPROM 45 is used in the passive safety system 1 as a nonvolatile memory. Therefore, the seat occupancy information around the time when the ignition signal is outputted can be collected after a collision occurs and electrically erased. Namely, the seat occupancy information can be rewritten.

The EEPROM 45 is installed for storing a self-diagnostic data and used also for storing the seat occupancy information. Thus, an extra cost for a device for storing the seat occupancy information is not required. The EEPROM 45 also stores the collision information. Namely, data necessary for accident analysis or research is all stored in the EEPROM 45. This is convenient for collecting information on an accident.

The airbag ECU 4 is housed in a robust case 4a for securing reliable operation. Therefore, the EEPROM 45 is protected from an impact of an accident and collected in a good condition after a collision.

The present invention should not be limited to the embodiment previously discussed and shown in the figures, but may be implemented in various ways without departing from the spirit of the invention. For example, the seat occupancy condition can be determined by a pressure-sensitive film sensor, a seat displacement sensor, an infrared sensor, or a CCD camera. The collision determination can be performed by a satellite acceleration sensor arranged at the front or a side of the vehicle. Such, sensors can be used in combination.

The period for writing the seat occupancy information and the collision information into the EEPROM 45 is not limited to the one that described in the above embodiment. The period may be started before of after the ignition signal is outputted. The period may be ended at time when the load sensor 20a-20d is damaged. A seat belt tensioner ECU and a seat belt may be used as a passive safety ECU and a passive safety device, respectively.

1. A passive safety system comprising:
an occupant detection electronic control unit that determines a seat occupancy condition of a vehicle seat and outputs a result of the determination as seat occupancy information; and
a passive safety electronic control unit that drives a passive safety device, wherein
the passive safety electronic control unit includes a collision determination circuit and a nonvolatile memory,
the collision determination circuit sets the passive safety device either in an operation permitted condition or an operation prohibited condition based on the seat occupancy information,
the collision determination circuit determines whether a collision occurs,
the collision determination circuit outputs a drive signal for driving the passive safety device when a collision is determined and the passive safety device is set in the operation permitted condition, and
the nonvolatile memory performs writing operation for storing the seat occupancy information, the writing operation being triggered by the drive signal.

2. The passive safety system according to claim 1, wherein the nonvolatile memory is an electrically erasable programmable read-only memory.

3. The passive safety system according to claim 1, wherein:
the passive safety electronic control unit further includes an acceleration sensor that detects an acceleration of the vehicle; and
the nonvolatile memory stores collision information that contains the acceleration detected by the acceleration sensor.

4. The passive safety system according to claim 1, wherein the passive safety electronic control unit is housed in a robust case for securing reliable operation.

5. The passive safety system according to claim 1, wherein the passive safety electronic control unit is an airbag electronic control unit that controls operation of an airbag.
